(19) United States
(12) Patent Application Publication
(10) Pub. No.: US 2011/0134127 A1
(43) Pub. Date: Jun. 9, 2011

(54) Global Career Graph

(76) Inventors: Ravishankar Gundlapalli, San Jose, CA (US); Subashree Krishnan, Sunnyvale, CA (US)

(21) Appl. No.: 12/630,797

(22) Filed: Dec. 3, 2009

(51) Int. Cl. G06T 11/20; G06Q 99/00

(52) U.S. Cl. 345/440; 705/1.1

(57) ABSTRACT

Disclosed is a method, comprising a) capturing a career journey for each individual of a plurality of individuals, wherein the career journey for an individual is represented as an individual career graph comprising nodes and edges connecting at least some of the nodes, and wherein each node represents a position expressed as a combination of a role for the individual at a particular organization and each edge represents a transition from one node to another; and b) aggregating the individual career graphs of the plurality of individuals into a global career graph.

### FIELD

The present invention relates to system and method for representing career journeys of individuals.

### BACKGROUND

An individual's career story (also journey or history) may be presented in a format that includes the name of individual first, followed by the individual's career journey. For example, for a particular individual, the individual's career journey may be presented as follows: Name of individual; graduated from a particular college with an undergraduate degree (e.g. Stanford University) took up a job as a Junior Analyst at Forrester Research, went on to become a Senior Analyst with Gartner, and then became a Principal at Silicon Valley Bank. In this example, the destinations of the individual are: Stanford, Forrester, Gartner and Silicon Valley Bank. The roles the individual played at these destinations are: Student, Junior Analyst, Senior Analyst, and Principal.

Presenting an individual's career journey in the above-described format leaves many questions unanswered. Examples of such questions include: a) How many individuals around the world have ever played the role of Junior Analyst at Forrester? b) How many individuals around the world have become a Principal at Silicon Valley Bank, after having worked as a Junior Analyst at Forrester? c) If there were one hundred individuals who played the role of Principal at Silicon Valley Bank, did they all arrive there from the same previous destination? Did they all do exactly the same things to get to becoming Principal at Silicon Valley Bank? Where did the individuals go after playing the role Principal at Silicon Valley Bank? d) If I am a recruiter looking to hire someone for the role of ‘Principal at Silicon Valley Bank’, can I find out all the possible ‘current roles’ of individuals to find ‘who at which role’ is statistically more likely candidate I should be talking to? Can I figure out all the ‘cumulative set of skills’ that the 100 individuals in example c) above had to use or have to get to the role of ‘Principal at Silicon Valley Bank? e) If I am an individual playing the role of Principal at Silicon Valley Bank, how do I really compare with the millions of professionals out there? How does my career story compare with everyone else? Am I an Outlier, or am I on a very determinate path? Are there ways I can project myself onto the global stage and figure out what steps I can take to get to my next destination? f) If I am a HR manager of a very large organization giving career guidance to a new employee who has a specific 5-year or 10-year career goal, how can I show him or her all the ways he or she can get to the role, and what skills, actions, decisions he or she needs to make over the next few years to get to the ‘dream career role’? g) If I am the President of an academic institution, can I see the career destinations of all our graduates (alumni)? They all started at the very same place but how did they all build their career stories. if I have to mentor someone just graduating, what tools and information can I use to show the plethora of options available to the graduating student, and all the steps the student can take to reach different destinations? Or can the student go on an un-explored path, and become a true ‘outlier’?

### SUMMARY

In one aspect, the present disclosure provides a method, comprising a) capturing a career journey for each individual of a plurality of individuals, wherein the career journey for an individual is represented as an individual career graph comprising nodes and edges connecting at least some of the nodes, and wherein each node represents a position expressed as a combination of a role for the individual at a particular organization and each edge represents a transition from one node to another; and b) aggregating the individual career graphs of the plurality of individuals into a global career graph.

In another aspect, the present disclosure provides a system comprising a display screen; and a processor coupled to the display screen, the processor comprising: a) a graph generating module for capturing a career journey for each individual of a plurality of individuals, wherein the career journey for an individual is represented as an individual career graph comprising nodes and edges connecting at least some of the nodes, and wherein each node represents a position expressed as a combination of a role for the individual at a particular organization and each edge represents a transition from one node to another; and b) a graph aggregating module for aggregating the individual career graphs of the plurality of individuals into a global career graph.

In yet another aspect of the present disclosure, the present disclosure provides computer-implemented methods, computer systems and a computer readable medium containing a computer program product, comprising: a) program code for capturing a career journey for each individual of a plurality of individuals, wherein the career journey for an individual is represented as an individual career graph comprising nodes and edges connecting at least some of the nodes, and wherein each node represents a position expressed as a combination of a role for the individual at a particular organization and each edge represents a transition from one node to another; and b) program code for aggregating the individual career graphs of the plurality of individuals into a global career graph.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

FIG. 1 shows individual career graphs of a plurality of individuals, in accordance with an embodiment of the present disclosure;

FIG. 2 is a block diagram of a system for generating a Global Career Graph, in accordance with an embodiment of the present disclosure;

FIG. 3 shows a first level architecture of the system, in accordance with an embodiment of the present disclosure;

FIG. 4 shows a second level architecture of the system, in accordance with an embodiment of the present disclosure;

FIG. 5 shows a flow chart for capturing information about various nodes, in accordance with an embodiment of the present disclosure;

FIG. 6 shows a flow chart for capturing information about various nodes, in accordance with an embodiment of the present disclosure;

FIG. 7 shows a Resume Parser of the system, in accordance with an embodiment of the present disclosure;

FIG. 8 shows a Nodal Aggregation Flow Chart, in accordance with an embodiment of the present disclosure;

FIG. 9 shows a flow chart representing a method for aggregating nodes, in accordance with an embodiment of the present disclosure;

FIG. 10 shows a usage of the Global Career Graph, in accordance with an embodiment of the present disclosure; and

FIG. 11 is a flow chart for pivot analysis on a node with projection into future, in accordance with an embodiment of the present disclosure.

The method and system have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Before describing in detail embodiments that are in accordance with the present disclosure, it should be observed that the embodiments reside primarily in combinations of method steps and system components related to career journeys of individuals.

As used herein, relational terms such as first and second, and the like may be used solely to distinguish one module or action from another module or action without necessarily requiring or implying any actual such relationship or order between such modules or actions. The terms “comprises,” “comprising,” or any other variation thereof, are intended to cover a non-exclusive inclusion, such that a process, method, article, or apparatus that comprises a list of elements that does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Any embodiment described herein is not necessarily to be construed as preferred or advantageous over other embodiments. All of the embodiments described in this detailed description are illustrative, and provided to enable persons skilled in the art to make or use the disclosure and not to limit the scope of the disclosure, which is defined by the claims.

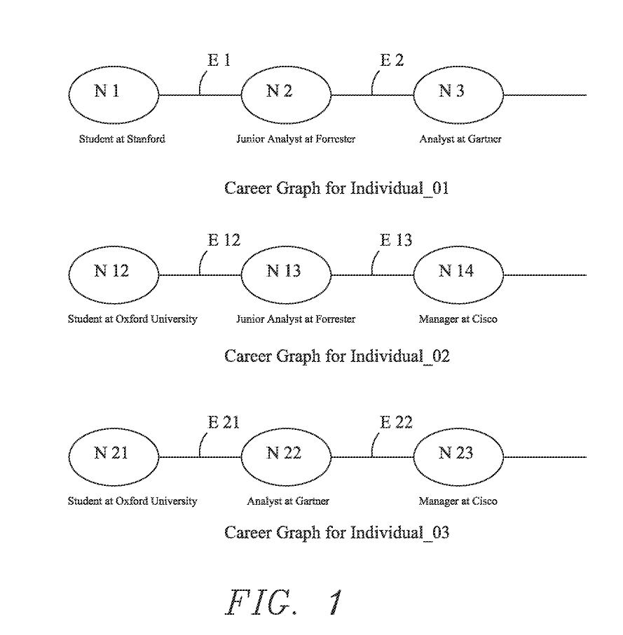

Referring to FIG. 1, individual career graphs of a plurality of persons is shown, in accordance with an embodiment of the present disclosure. Specifically, FIG. 1 illustrates career journeys for three different of individuals. The career journey for an individual is represented as an individual career graph comprising nodes and edges. Each node such as node Ni represents a role or designation for the individual at a particular organization and each edge such as El represents a transition from one node to another. In other words, an edge connects two nodes. Further, an edge may interchangeably be called as a Nodal Connector (NC).

In one embodiment of the present disclosure, the career graph includes a plurality of nodes or milestones being achieved by the individual. In other words, each node in the career graph represents “a role/designation of the individual at an organization/destination”. For example, a first node N1 of the career graph of the individual_01 may represent that the individual_01 was a Student at Stanford, wherein Student is the designation and Stanford is the organization. Similarly, a second node N2 of the career graph of the individual_01 may represent that the individual_01 was a Junior Analyst at Forrester; and a third node N3 may represent that the individual_01 is an Analyst at Gartner. Therefore, the first node N1, the second node N2, and the third node N3 represent the career graph of the individual_01.

Similarly, a career graph for individual_02 is as shown in FIG. 1. Specifically, the career graph of individual_02 has three nodes. A first node N12 of the career graph of the individual_02 represents that the individual_02 was a Student at Oxford University. A second node N13 of the career graph of the individual_02 may represent that the individual_02 was a Junior Analyst at Forrester; and a third node N14 may represent that the individual_02 is a Manager at Cisco. Therefore, the first node N12, the second node N13, and third node N14 of the individual_02 represent the career graph of the individual_02.

Similarly, a career graph of individual_03 is shown in FIG. 1. Specifically, the career graph of individual_03 has three nodes. A first node N21 of the career graph of the individual_03 represents that the individual_03 was a Student at Oxford University. A second node N22 of the career graph of the individual_03 may represent that the individual_03 was an Analyst at Gartner; and a third node N23 may represent that the individual_03 is a Manager at Cisco. Therefore, the first node N21, the second node N22, and the third node N23 of the career graph of the individual_03 represent the career graph of the individual_03. Similarly, individual career graphs of N individuals may be created to form a database.

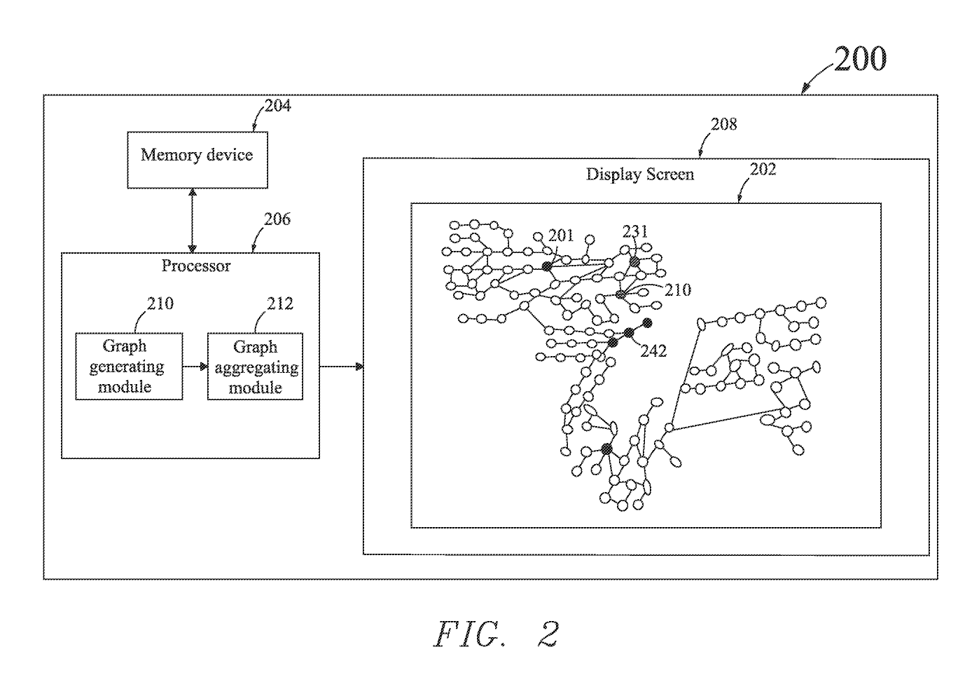

Referring now to FIG. 2, a block diagram of a system 200 for generating a Global Career Graph 202 is shown, in accordance with an embodiment of the present disclosure. In one embodiment, the system 200 is an electronic device such as a computer; however in another embodiment the system may be a mobile phone or any other electronic device which has a display screen.

The system 200 includes a memory device 204, a processor 206, and a display screen 208. The memory device 204 may be used to store the database which may help to generate the Global Career Graph (GCG) 202. The memory device 204 is coupled to the processor 206. The processor 206 includes a graph generating module 210 and a graph aggregating module 212. The graph generating module 210 may capture a career journey for each individual of a plurality of individuals. The graph aggregating module 212 may aggregate the individual career graphs of the plurality of individuals into the Global Career Graph 202.

The GCG 202 may have thousands of nodes belonging to career graphs of hundreds of individuals; however only a few nodes have been shown in the GCG 202. In one embodiment, the GCG 202 is formed by synthesizing the career graphs of all individuals into a Global Career Graph, wherein all the individual career graphs are aggregated based on commonality of nodes. In other words, all nodes and edges of the individual career graphs are aggregated based on commonality of nodes and edges, respectively. For example, all the individuals who have ever been managers at Cisco would be represented by a single node such as node 201 in the GCG 202. Similarly, all the individuals who have been students at Oxford University would be represented by another node such as node 231 in the GCG 202.

It is to be understood that each node in the GCG 202 represents designation of N persons at an organization, wherein N is a number of persons who have ever been at that designation at that organization, and wherein N may be different for different nodes at GCG 202. For example, node 210 represents that N persons have been Students at Stanford at one point of a time. Similarly, node 242 represents that K persons have been Junior Analyst at Forrester at one point of a time.

Advantageously, GCG 202 is a way to visually present career graphs of individuals around the world. An individual's career graph involves specific career destinations, and paths between those various destinations. A global aggregation of all such career destinations around the world, combined with the aggregation of all the edges/paths between those destinations will then look like a complex, interconnected map—of destinations and paths. GCG 202 is an embodiment of such complex and interconnected map.

Further, the system 200 allows a user to select a beginning node and a destination node from the system 200 on the GCG 202. In response to the selection, a plurality of sub-graphs is extracted wherein each sub-graph shows the selected beginning node and the selected destination node. The sub-graphs are displayed on the display screen 208. Furthermore, the system 200 allows a user to select a particular node as a pivotal node from the GCG 202. Subsequently, the system 200 calculates all possible career journeys to and from the pivotal node and displays the possible career journeys on the display screen 208. Additionally, the system 200 allows a user to select a particular node from the GCG 202. Based on the selection, the system 200 displays individual career graphs that include the selected node.

In one embodiment of the present disclosure, each node in the GCG 202 is associated with a plurality of attributes. The attributes are collectively referred to as Career Nodal Attributes (CNAs). Some of the CNAs are: 1) Names of individuals who have ever been at that position; 2) Date of arrival of each individual at that position; 3) Skills used by each individual to arrive at that position; 4) Key decisions made by each individual to arrive at that position; 5) Key accomplishments by each individual before arriving at that position; 6) Key resources that helped each individual to arrive at that position; 7) The industry that the role & organization represents for each individual. The seven attributes mentioned above are captured at the node, and represented by a unique nomenclature as illustrated below:
N209_12_CNA01 represents CNA1 (name) of the Individual 2 at node 209.
N209_12_CNA02 represents CNA2 (date of arrival) of the individual 2 at node 209, and so on.
   Sample data captured will be as follows:
N209_12_CNA01: Matt Cragen; 2007; Negotiating—Selling—Team Work; Moved to corporate headquarters—Began to meet customers; Generated 4 Million Dollar revenue in a year; Steve Henley coached me on selling skills—Took an executive course on Negotiating; Banking and Financial Services (BFSI)

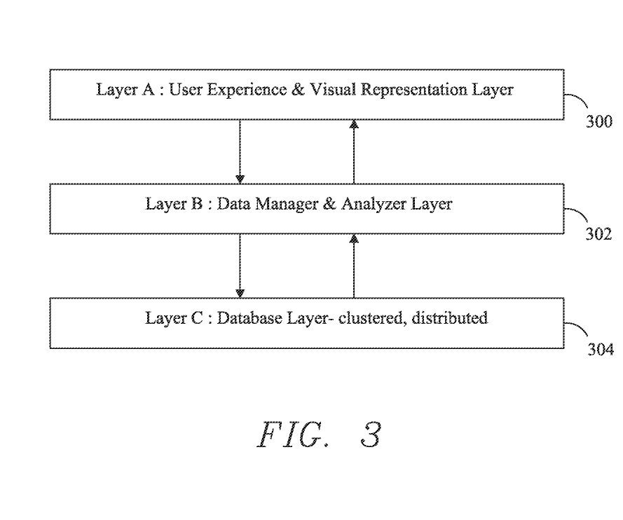

Referring now to FIG. 3, a first level architecture of the system 200 is shown, in accordance with an embodiment of the present disclosure. Specifically, at Layer A 300 is a User Experience and Visual Representation layer. The Layer A 300 helps the system 200 to capture information about the nodes and CNAs. Further, graphical tools to represent the nodes, CNAs and Nodal Connectors (NCs) are also constructed in the Layer A 300. Further, Layer B 302 is a Data Manager and Analyzer layer. The Layer B 302 helps the system 200 to aggregate the nodes, its CNA attributes, and generates programmatic calls to store the data in the database. Nodal Connections are also constructed in the Layer B 302 and are stored in the database. Furthermore, Layer C 304 is a Database layer. The Layer C 304 helps the system 200 to store data quickly and retrieve to the User Experience and Visual Representation layer, on demand. The data model is built using a proprietary Web Ontology Language Processor (WOLP) to logically connect nodes, Nodal Connections, and aggregate CNAs.

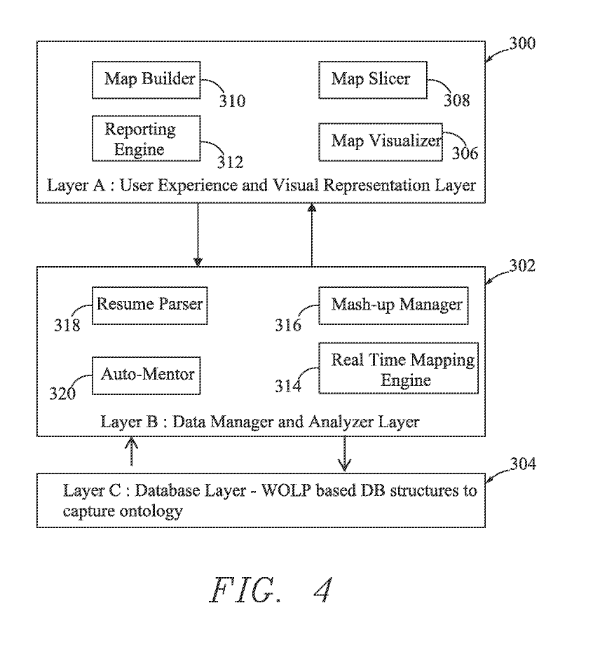

Each of these layers in turn has several sub-components as shown in FIG. 4. Specifically, FIG. 4 shows a second level architecture of the Global Career Graph, in accordance with an embodiment of the present disclosure. For example, Layer A 300 i.e. the User Experience and Visual Representation Layer consists of four sub components, namely a Map Visualizer 306, a Map Slicer 308, a Map Builder 310, and a Reporting Engine 312. The Map Visualizer 306 encapsulates all visual map/graph representation methods. The Map Slicer 308 encapsulates map traversal algorithms to help zoom in sections of the map defined by an originating node and a destination node. The Map Builder 310 encapsulates all visual and data recording methods to capture the Designation at Organization or node for each individual. The Reporting Engine encapsulates reporting functionality.

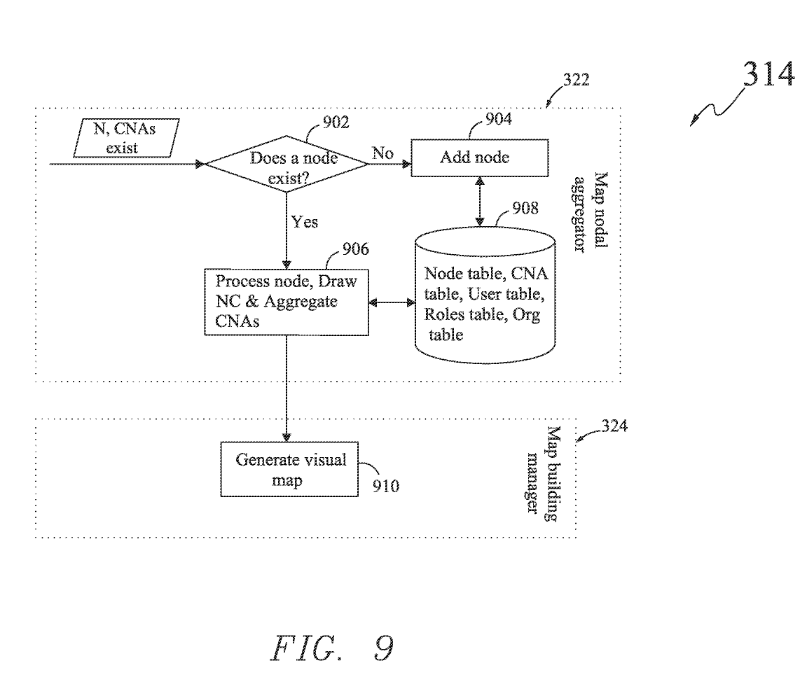

Similarly, the Layer B 302 i.e. the Data Manager & Analyzer Layer consists of four modules, namely a Real Time Mapping Engine 314, a Mash-up Manager 316, a Resume Parser 318, and an Auto-mentor 320. The Real Time Mapping Engine 314 further includes a Map Nodal Aggregator 322 and a Map Building Manager 324 (as shown in FIG. 9). Each of these components will be explained in detail later in the description. The Mash-up Manager 316 Manager encapsulates third party application interfaces either through web services, RSS or other data transfer means to feed data into the Resume Parser, as will be explained.

Similarly, the Layer C 304 i.e. the Database Layer consists of tables such user profile table, career milestone table, structures, career ontology, career history, and career map tables. Some of these tables are modeled in relational databases while others are modeled based on WOLP (Web Ontology Language Processor).

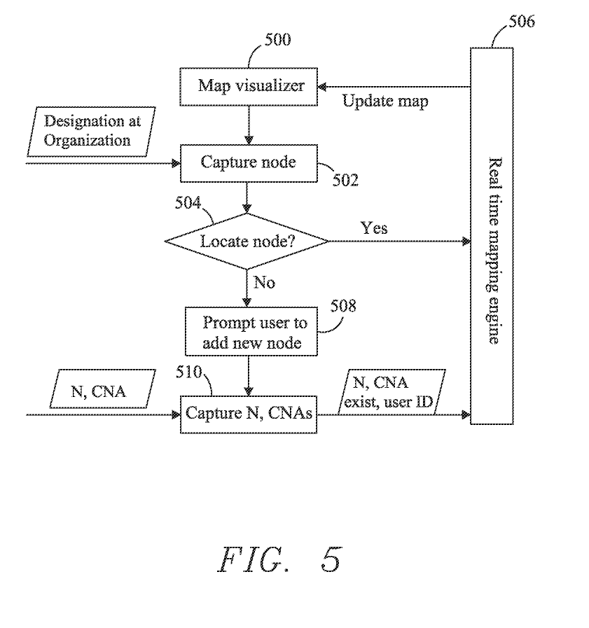

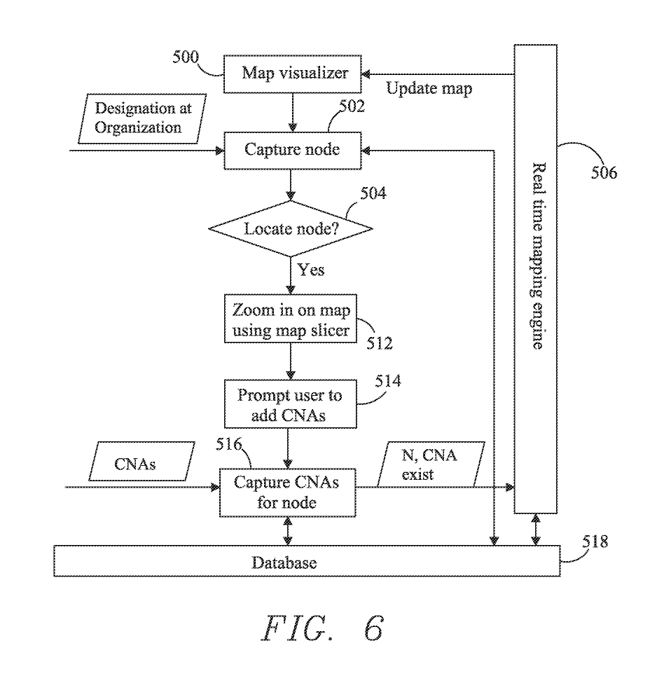

Referring now to FIGS. 5 and 6, flow charts for capturing information about various nodes is shown, in accordance with an embodiment of the present disclosure. Specifically, the flow charts explain a method of capturing information about Designation at an Organization for various individuals. At 500, a user is initially presented with a graphical map showing all the currently existing nodes and Nodal Connectors using the Map Visualizer 306. At 502, the user is first prompted to enter his or her Designation at an Organization. The system 200 creates a Dynamic In-Memory node and searches the Database for existence of that node. At 504, it is determined whether the node exists. if yes, then at 506 the Dynamic In-Memory node is replaced with the Current node in the system, and the user is presented a zoomed-in map with that specific node in spotlight with the help of the Map Slicer 308. However, if that node doesn't exist in the Database, then at 508 the Dynamic In-Memory node is now assigned a New node ID, and the user is prompted to enter the Nodal information of a New node. At 510, the user enters Career Nodal Attributes for the New node. Further, the user might come back to the system 200 at a later time to enter just the CNAs of an existing node as shown in FIG. 6. If the node already exists in the GCG 202, then the user is prompted to enter the CNAs for that node as shown by the flow chart in FIG. 6.

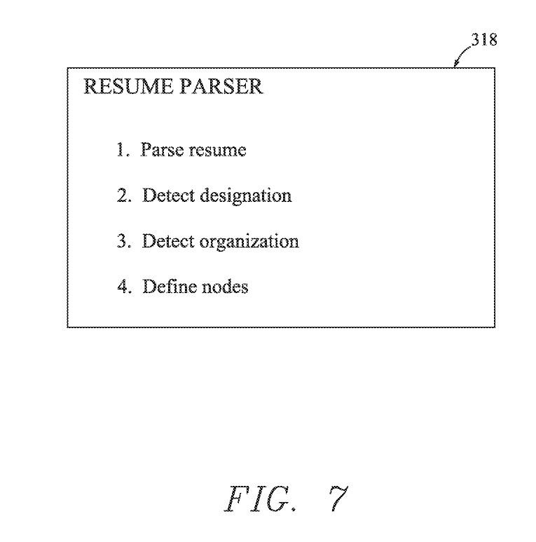

Referring now to FIG. 7, the system 200 also includes an automated Resume Parser 318 to allow an individual upload the resume either directly from system 200 User Interface, or provide a web link (URL) to another public domain where the resume is already available. The Resume Parser 318 reads the content in the Resume of an individual, detect designation of the individual, detect organization of the individual, and then define a node for the individual. The Resume Parser 318 then prompts the user to enter CNAs.

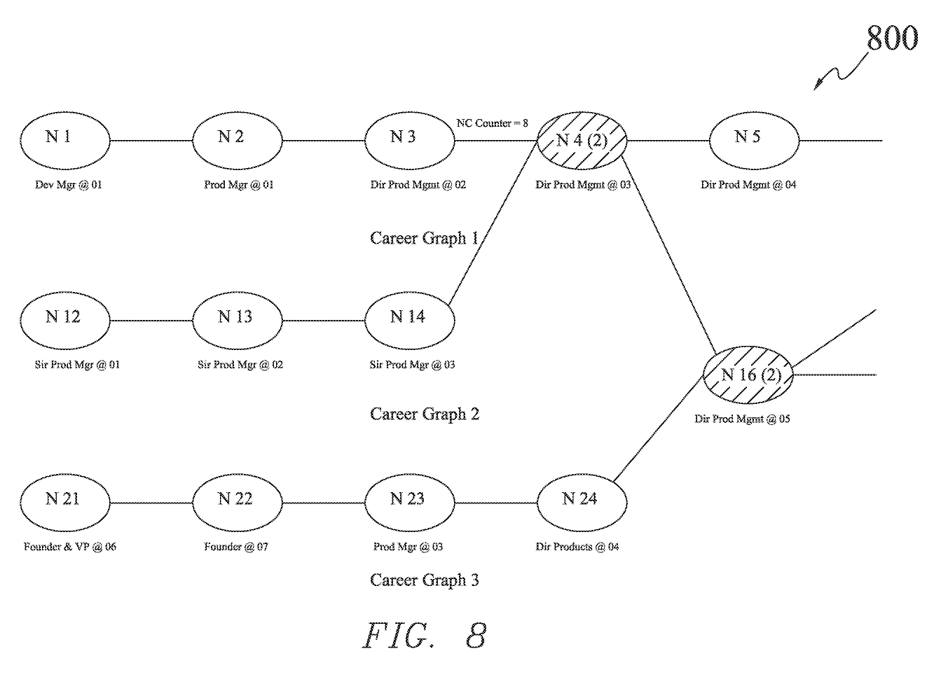

Referring now to FIG. 8, a Nodal Aggregation Flow Chart 800 is shown, in accordance with an embodiment of the present disclosure. node 4 and node 16 are ‘Common nodes’ i.e. career journeys of two individuals contain nodes 4 and 16. Identification of this ‘Commonality’ is called ‘Nodal Aggregation’ as shown in FIG. 8. As previously explained, the lines connecting any two nodes are called ‘Nodal Connectors (NCs)’ or edges. In GCG 202, Nodal Connectors or edges represent that someone has gone from node 1 to node 2. In FIG. 8, one of the node Connectors shows that an individual has gone from node 14 to node 4.

By identifying common nodes and edges and aggregating them, one would be able to recognize that more than one career paths can lead to the same node in the GCG 202. However, the path traversed by that individual between any two nodes is unique to that person who is captured using the CNAs or Career Nodal Attributes as explained in the previous section.

Further, a first counter is associated with each node. A count of 2 for node 14 indicates that this node 14 has occurred twice in the GCG 202. This means that two individuals have been at node 14 at some point in time. Similarly, a second Counter is also associated with the Nodal Connectors or edges. In FIG. 8, the Nodal Connector between node 3 and node 4 shows a counter of 8. This means that 8 individuals have moved from node 3 to node 4. The underlying CNAs of node 3 and node 4 will contain data for each of those 8 individuals.

Referring now to FIG. 9, shows a flow chart representing a method for aggregating nodes, in accordance with an embodiment of the present disclosure. The node aggregation is performed by the Real Time Mapping Engine 314 having the Map nodal aggregator 322 and the Map building manager 324. At 902, the Map nodal aggregator 322 determines whether a node entered by a user exists or not. If no, then the user is prompted to add a node at 904. Otherwise, at 906, the node is processed having the edges drawn and the CNAs getting aggregated. Further, at 908, a node table, a CNAs table, a user table, a role table, and an organization table is created. Subsequently, at 910, the Map building manager 324 generates a visual map for the user.

It is to be understood that the Real Time Mapping Engine 314 helps in generation of GCG 202 when all nodes have already been captured and associated with Career Nodal Attributes. The Career Nodal Attributes may be captured using a CNA Capture questionnaire having following questions:
Q1—What is your name?
Q2—When did you arrive at this node?
Q3—What were the top 3 skills which you used to reach this node?
Q4—What were the top 3 decisions you made to reach this node gracefully?
Q5—What were the top 3 accomplishments that helped you reach this node?
Q6—If you were to identify 2 key inputs and 2 people who helped you get to this node, what and who would that be?
Q7—What is the Industry in which you were at this node?

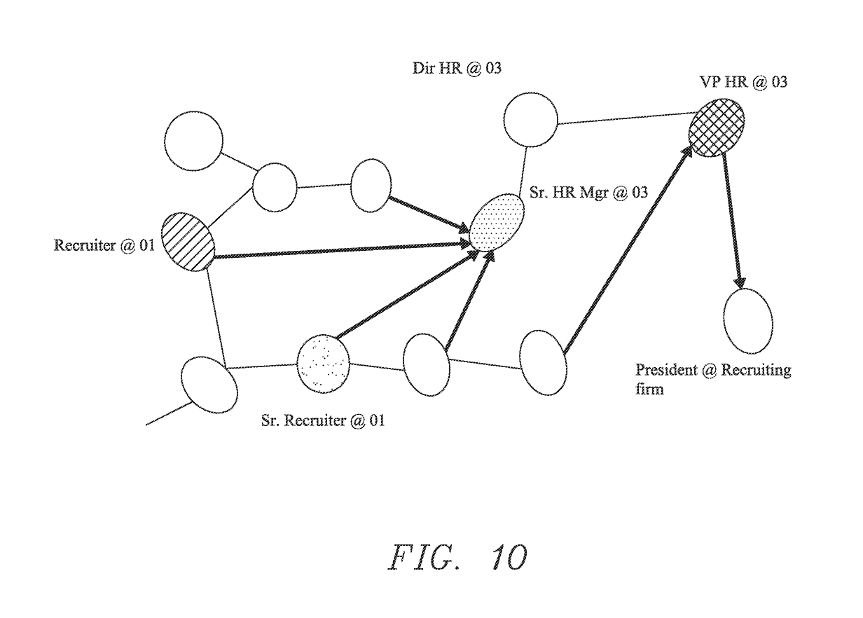

Referring now to FIG. 10, a usage of the GCG 202 is illustrated, in accordance with an embodiment of the present disclosure. Specifically, FIG. 10 illustrates a mentoring guidance application. Let us consider the example of the node ‘Recruiter at O1’ as a pivotal point and project the possible career paths to arrive at the node ‘VP HR at O3’. FIG. 10 represents a sub-graph that has been extracted from the GCG 202.

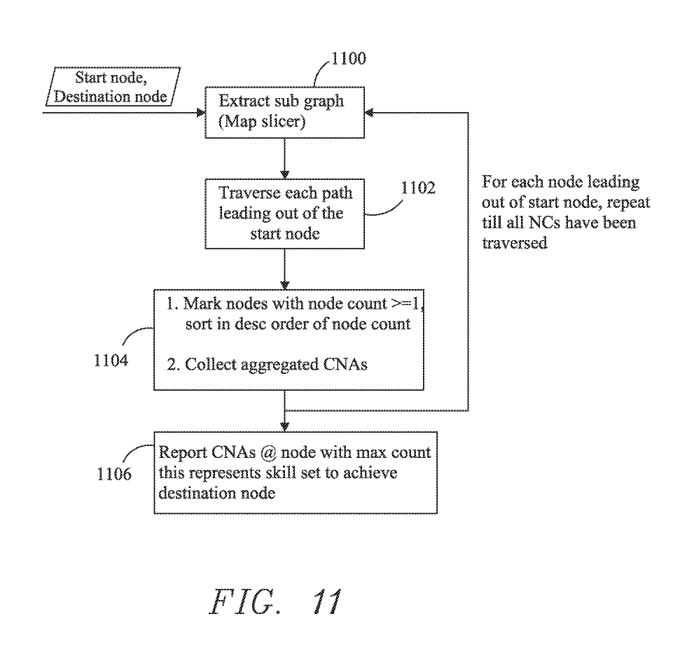

Referring now to FIG. 11, a flow chart for pivot analysis on a node with projection into future is shown, in accordance with an embodiment of the present disclosure. At 1100, the Map Slicer 308 extracts a sub-graph from the GCG 202 as per user's input about a start node. At 1102, each path/edge leading out of the start node is traversed in the sub-graph. At 1104, the nodes with node count ≦1 are marked and sorted in descending order of node count. Further, aggregated CNAs are also collected at 1104. At 1106, CNAs at a node having a maximum node count is reported. The represents skill set needed to achieve a destination node.

Further, the GCG 202 may be used for a variety of purposes/applications. For example, the GCG 202 has an ability to project a given node onto GCG 202: For example for a node ‘Product Manger at Cisco’ a user can use the system to a) Identify how many professionals are there or have been there at that particular node; b) Gain insights into various possibilities for the path ahead, for picking an optimum set of actions to get to the next ‘potential’ node; c) Learn how other people got to this particular node, by studying the all the attributes captured within a ‘Paths to nodes’ (P2Ns) of other people who are or have arrived at this node before;

Further, GCG 202 is further capable of visually representing an individual's career and how it matches up with the rest of the professional population around the world. The GCG 202 benchmarks the individual's career journey with everyone else in the world. Furthermore, the GCG 202 is capable of rendering as a snapshot for a particular organization at a particular time. Specifically, when a user pulls out data by organization and fixes the ‘Time’ attribute within P2N as Current, then the GCG 202 renders a snapshot of the graph for that particular organization at the current time. Such a rendering may also help an HR professionals guide the employees on available career paths within the organization. Further, this feature may also be used to compare aggregated skill set between two different organizations.

Furthermore, GCG 202 is further provides an ability to recruiters to pivot at a node for which the recruiters are hiring for, study the P2Ns of various individuals who arrived at that node, as a way to create job descriptions as well as to identify potential candidates. Therefore, GCG 202 provides recruiters with an ability to clearly identify the skills required to arrive at a particular node for which the recruiters are hiring. GCG 202 can provide invaluable guidance for those recruiting for specific nodes within a global professional career map.

GCG 202 further provides ability to clearly identifying outliers. Let us say node 56,345 represents Senior Student at Stanford. Generating a GCG 202 with this node 56,345 as the pivot point will give career journeys of all Senior Students out of Stanford. Not only is this information incredibly valuable to a university, such a map can also identify who are those few individuals who took a completely different path from the others, and became successful (outliers). GCG 202 captures outbound career maps of a university's alumni by way of pivoting at an exit node of the university.

Moreover, the GCG 202 provides an ability to view corporate executive profiles in a visual format, and be able to compare those executives with other executives around the world. Semantic algorithms within the GCG 202 system will read the text, identify the nodes and then project the executive onto GCG 202. Few embodiments of the GCG 202 system are projected to be used in the following applications: a) Mentoring of individuals to reach their career goals—in academic institutions and within organizations b) Hiring the right kind of talent for the right role, in the most effective manner c) Projecting oneself onto a global career map and reflecting to take appropriate actions d) Statistical reporting of career destinations and paths, for organizational planning as well as for curriculum development within an academic institution.

Therefore, the GCG 202 answers the following questions: a) How many individuals around the world have ever played the role of Junior Analyst at Forrester? b) How many individuals around the world have become a Principal at Silicon Valley Bank, after having worked as a Junior Analyst at Forrester? c) if there were 100 individuals who played the role of Principal at Silicon Valley Bank, did they all arrive there from the same previous destination? Did they all do exactly the same things to get to becoming Principal at Silicon Valley Bank? Where did the individuals go after playing the role Principal at Silicon Valley Bank? d) if I am a recruiter looking to hire someone for the role of ‘Principal at Silicon Valley Bank’, can I find out all the possible ‘current roles’ of individuals to find ‘who at which role’ is statistically more likely candidate I should be talking to? Can I figure out all the ‘cumulative set of skills’ that the 100 individuals in example c) above had to use or have to get to the role of ‘Principal at Silicon Valley Bank? e) If I am an individual playing the role of Principal at Silicon Valley Bank, how do I really compare with the millions of professionals out there? How does my career story compare with everyone else? Am I an Outlier, or am I on a very determinate path? Are there ways I can project myself onto the global stage and figure out what steps 1 can take to get to my next destination? f) If I am a HR manager of a very large organization giving career guidance to a new employee who has a specific 5-year or 10-year career goal, how can I show him or her all the ways he or she can get to the role, and what skills, actions, decisions he or she needs to make over the next few years to get to the ‘dream career role’? g) If I am the President of an academic institution, can I see the career destinations of all our graduates (alumni)? They all started at the very same place but how did they all build their career stories. If I have to mentor someone just graduating, what tools and information can I use to show the plethora of options available to the graduating student, and all the steps the student can take to reach different destinations? Or can the student go on an un-explored path, and become a true ‘outlier’?

It will be appreciated that embodiments of the disclosure described herein may comprise one or more conventional processors and unique stored program instructions that control the one or more processors to implement, in conjunction with certain non-processor circuits, some, most, or all functions of processing a sensor data. Alternatively, some or all functions of processing a sensor data could be implemented by a state machine that has not stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

As will be understood by those familiar with the art, the disclosure may be embodied in other specific forms without departing from the spirit or essential characteristics thereof. Likewise, the particular naming and division of the modules, agents, managers, functions, procedures, actions, methods, classes, objects, layers, features, attributes, methodologies and other aspects are not mandatory or significant, and the mechanisms that implement the disclosure or its features may have different names, divisions and/or formats. Furthermore, as will be apparent to one of ordinary skill in the relevant art, the modules, agents, managers, functions, procedures, actions, methods, classes, objects, layers, features, attributes, methodologies and other aspects of the disclosure can be implemented as software, hardware, firmware or any combination of the three. Of course, wherever a component of the present disclosure is implemented as software, the component can be implemented as a script, as a standalone program, as part of a larger program, as a plurality of separate scripts or programs, as a statically or dynamically linked library, as a kernel loadable module, as a device driver, and/or in every and any other way known now or in the future to those of skill in the art of computer programming. Additionally, the present disclosure is in no way limited to implementation in any specific programming language, or for any specific operating system or environment. Accordingly, the disclosure of the present disclosure is intended to be illustrative, but not limiting, of the scope of the disclosure, which is set forth in the following claims.

I/We claim:

1. A method, comprising:
capturing a career journey for each individual of a plurality of individuals, wherein the career journey for an individual is represented as an individual career graph comprising nodes and edges connecting at least some of the nodes, and wherein each node represents a position expressed as a combination of a role for the individual at a particular organization and each edge represents a transition from one node to another; and
aggregating the individual career graphs of the plurality of individuals into a global career graph.

2. The method of claim 1, wherein the aggregating comprises aggregating the nodes based on commonality of nodes of the individual career graphs of the plurality of individuals.

3. The method of claim 1, wherein the aggregating comprises aggregating the edges between same nodes of the individual career graphs of the plurality of individuals.

4. The method of claim 2, further comprising maintaining a first counter for the aggregated nodes in the global career graph.

5. The method of claim 3, further comprising maintaining a second counter for the aggregated edges in the global career graph.

6. The method of claim 1, further comprising allowing a user to select a beginning node and a destination node from the global career graph; and responsive to the selection extracting sub-graphs having the selected beginning node and the selected destination node; and displaying the sub-graphs.

7. The method of claim 1, further comprising allowing a user to select a particular node as a pivotal node from the global career graph; calculating all possible career journeys from the pivotal node; and displaying the possible career journeys.

8. The method of claim 1, further comprising allowing a user to select a particular node as a pivotal node from the global career graph; calculating all possible career journeys to that the pivotal node; and displaying the possible career journeys.

9. The method of claim 1, further comprising allowing a user to select a particular node from the global career graph; and responsive to the selecting, displaying individual career graphs that include the selected node.

10. The method of claim 1, further comprising capturing nodal attributes for each node of the individual career graph of each individual.

11. The method of claim 10, wherein the nodal attributes is selected from a group consisting of name of the individual; a start date for the position associated with the node; skills used to obtain the position; key decisions made while at the position; key accomplishments before obtaining the position; key resources that assisted in obtaining the position; an industry associated with the position.

12. A system, comprising
a display screen; and
a processor coupled to the display screen, the processor comprising:
a graph generating module for capturing a career journey for each individual of a plurality of individuals, wherein the career journey for an individual is represented as an individual career graph comprising nodes and edges connecting at least some of the nodes, and wherein each node represents a position expressed as a combination of a role for the individual at a particular organization and each edge represents a transition from one node to another; and
a graph aggregating module for aggregating the individual career graphs of the plurality of individuals into a global career graph.

13. The computer readable medium containing a computer program product, comprising:
program code for capturing a career journey for each individual of a plurality of individuals, wherein the career journey for an individual is represented as an individual career graph comprising nodes and edges connecting at least some of the nodes, and wherein each node represents a position expressed as a combination of a role for the individual at a particular organization and each edge represents a transition from one node to another; and
program code for aggregating the individual career graphs of the plurality of individuals into a global career graph.

14. The computer program product of claim 13, wherein program code for the aggregating comprises program code for aggregating the nodes based on commonality of nodes of the individual career graphs of the plurality of individuals.

15. The computer program product of claim 13, wherein program code for the aggregating comprises program code for aggregating the edges between same nodes of the individual career graphs of the plurality of individuals.

16. The computer program product of claim 13, further comprising program code for allowing a user to select a beginning node and a destination node from the global career graph; and responsive to the selection extracting sub-graphs having the selected beginning node and the selected destination node; and displaying the sub-graphs.

17. The computer program product of claim 13, further comprising program code for allowing a user to select a particular node as a pivotal node from the global career graph; calculating all possible career journeys from the pivotal node; and displaying the possible career journeys.

18. The computer program product of claim 13, further comprising program code for allowing a user to select a particular node as a pivotal node from the global career graph; calculating all possible career journeys to that the pivotal node; and displaying the possible career journeys.

19. The computer program product of claim 13, further comprising program code for allowing a user to select a particular node from the global career graph; and responsive to the selecting, displaying individual career graphs that include the selected node.

20. The computer program product of claim 13, further comprising program code for capturing nodal attributes for each node of the individual career graph of each individual.
